(19) United States
(12) Patent Application Publication
(10) Pub. No.: US 2023/0046838 A1
(43) Pub. Date: Feb. 16, 2023

(54) NA EXCESS P3-TYPE LAYERED OXIDES AS CATHODE MATERIALS FOR SODIUM ION BATTERIES

(71) Applicant: National University of Singapore, Singapore (SG)

(72) Inventors: Balaya PALANI, Singapore (SG); Abhinav TRIPATHI, Singapore (SG)

(21) Appl. No.: 17/793,873

(22) PCT Filed: Jan. 21, 2021
(86) PCT No.: PCT/SG2021/050032

§ 371 Date: Jul. 19, 2022

(30) Foreign Application Priority Data
Jan. 21, 2020 (SG) 10202000553R

(51) Int. Cl. H01M 4/50; C01G 49/00

(52) U.S. Cl. CPC H01M 4/502; C01G 49/0072; C01P 2006/40; C01P 2002/50; C01P 2002/72; C01P 2004/03; C01P 2002/77; C01P 2002/20; H01M 2004/028

(57) ABSTRACT

Disclosed herein is a stabilised Na-ion oxide P3 phase of formula (I): P3-NaₓM_{y}O_{z} Where, x>0.66, 0.8≤y≤1.0, z≤2; and M is selected from one or more of the group consisting of a 3d transition metal, a 4d transition metal, Al, Mg, B, Si, Sn, Sr and Ca. The stabilised Na-ion oxide P3 phase of formula (I) may be particularly useful as an active material in a Na-ion battery.

### FIELD OF INVENTION

This invention relates to energy storage devices based on non-aqueous electrochemistry. More specifically, it relates to rechargeable Na/Na-ion batteries that make use of a P3 type layered oxide (e.g. P3-NaₓM_{y}O₂) with excess Na content as a cathode material for Na-ion batteries (NIB).

### BACKGROUND

The listing or discussion of a prior-published document in this specification should not necessarily be taken as an acknowledgement that the document is part of the state of the art or is common general knowledge.

Global energy demand is ever-growing, and current dependence on carbon-based energy sources is both costly and deemed unsustainable. Energy storage devices can unlock the potential of intermittent renewable energy sources (e.g. solar, wind and wave), which will in turn make the generation and use of energy sources more sustainable. Energy storage devices also provide effective solutions for decoupling energy source and energy utilization space, which may be needed in future with the advent of nuclear energy technology. Electrochemical systems are inherently efficient and energy intensive which make them an ideal choice for most energy storage technologies. Li-ion batteries have already proven their merit by dominating the portable device and transportation market. However, cheaper and abundant alternatives are necessary for stationary energy storage technologies so that they can be deployed on a large scale.

Na-ion resources are cheap and Na-ion batteries have almost the same performance (e.g. power, cycle life etc.,) as a Li-ion battery due to chemical and physical similarities. That is, the proximity in the periodic table makes Na-ion and Li-ion batteries chemically similar and the fundamentals of Li-ion and Na-ion batteries are exactly the same, making Na-ion battery technology a suitable alternative, especially for energy storage on an industrial scale. However, due to lack of high capacity cathodes, Na-ion batteries have garnered only moderate attention.

Na-ion layered oxides offer the highest theoretical capacity due to their lower molecular weight compared to other families of Na-ion cathode materials. Na-ion layered oxides have been classified as O3, P3, P2 and O1 types, depending upon the crystal environment and number of repeating layers in a unit cell (see C. Delmas, C. Fouassier and P. Hagenmuller, Physica B+C, 1980, 99, 81-85). The major classification as far as cathode materials are concerned falls into two types of these oxides—O3 and P2. There are many reports on these two types of Na-ion layered oxides (e.g. see M. H. Han, E. Gonzalo, G. Singh and T. Rojo, Energy & Environmental Science, 2015, 8, 81-102; and R. J. Clément, P. G. Bruce and C. P. Grey, Journal of The Electrochemical Society, 2015, 162, A2589-A2604). However, most of these layered oxides have an inverse relationship between capacity and cycling performance. That is, if a layered oxide has higher capacity, it might well show poor cyclability.

For example, O3-Na_{0.9}Cu_{0.22}Fe_{0.30}Mn_{0.48}O₂ and O3-NaLi_{0.1}Ni_{0.25}Mn_{0.75}O₂ display excellent cycling performance, however they deliver capacities in the range of 90-95 mAhg⁻¹ (see L. Mu, S. Xu, Y. Li, Y.-S. Hu, H. Li, L. Chen and X. Huang, Advanced Materials, 2015, 27, 6928-6933; and D. Kim, S.-H. Kang, M. Slater, S. Rood, J. T. Vaughey, N. Karan, M. Balasubramanian and C. S. Johnson, Advanced Energy Materials, 2011, 1, 333-336). On the other hand, O3 phases such as NaCoO₂, NaCrO₂, NaVO₂, and NaNi_{0.5}Mn_{0.5}O₂ show reversible capacities in the range of 120-140 mAhg⁻¹ but with poor cycling (see C. Delmas, J. J. Braconnier, C. Fouassier and P. Hagenmuller, Solid State Ionics, 1981, 3-4, 165-169; S. Komaba, C. Takei, T. Nakayama, A. Ogata and N. Yabuuchi, Electrochemistry Communications, 2010, 12, 355-358; S. Komaba, N. Yabuuchi, T. Nakayama, A. Ogata, T. Ishikawa and I. Nakai, Inorganic Chemistry, 2012, 51, 6211-6220; D. Hamani, M. Ati, J.-M. Tarascon and P. Rozier, Electrochemistry Communications, 2011, 13, 938-941). Poor cycle life of such cathodes is typically attributed to complex phase transformations observed during the charge/discharge process.

P2 layered oxides offer higher energy density, but they are sodium-deficient which means that one has to introduce a Na-resource at the anode to compensate for the Na deficiency. However, this eventually reduces cell energy density due to additional dead weight at the anode. For example, 0.66 moles of Na-ions are extracted from P2-Na_{0.66}Mn_{0.5}Fe_{0.5}O₂ in the first cycle during charge within the allowable voltage window, and 0.86 moles of Na-ions are inserted into the cathode during discharge from the anode (see N. Yabuuchi, M. Kajiyama, J. Iwatate, H. Nishikawa, S. Hitomi, R. Okuyama, R. Usui, Y. Yamada and S. Komaba, Nat. Mater., 2012, 11, 512-517) resulting in storage capacity of 190 mAh/g, but this excess Na during discharge must be supplied from anode. Thus, there is a limitation in terms of scarcity of Na-ions in P2 type layered oxides. As far as P3 type layered oxide cathodes are concerned, there are very few reports with Na-content lower than 0.66, thus demanding excess Na-ions supplied from the anode end to achieve a high capacity at the cathode. However, such a strategy leads to lower energy density of full-cell system as explained above due to additional weight of such additives at the anode (see Q. Huang, S. Xu, L. Xiao, P. He, J. Liu, Y. Yang, P. Wang, B. Huang and W. Wei, Inorganic Chemistry, 2018, 57, 15584-15591). The presodiation of a P3 type cathode prior to cell assembly on an industrial production scale is not feasible at the current time.

Thus, there remains a need for new materials that overcome some or all of the problems identified above.

### SUMMARY OF INVENTION

It has been surprisingly found that a P3 type layered oxide (e.g. P3-NaₓM_{y}O₂) with excess Na content can be advantageously used as a cathode material for Na-ion batteries (NIB), amongst other applications.

Aspects and embodiments of the invention will now be discussed by reference to the following numbered clauses.

1. A stabilised Na-ion oxide P3 phase of formula I:

P3-NaₓM_{y}O_{z} I

where:

x>0.66;

0.8≤y≤1.0;

z≤2; and

M is selected from one or more of the group consisting of a 3d transition metal, a 4d transition metal, Al, Mg, B, Si, Sn, Sr and Ca, wherein the compound of formula I is suitable for use as a cathode active material in a Na-ion battery.

2. The compound of formula I according to Clause 1, wherein M is selected from one or more of the group consisting of Mn, Fe, Ni, Co, Cu, Ti, Cr, Zn, V, Sc, Y, Zr, Nb, Mo, Al, Mg, B, Si, Sn, Sr and Ca.

3. The compound of formula I according to Clause 1, wherein M is selected from one or more of the group consisting of Mn, Fe, Ni, Co, Cu, Ti, Cr, Zn, V, Sc, Y, Zr, Nb, Mo, Al, Mg, B, and Ca, optionally wherein M is Ti.

4. The compound of formula I according to any one of the preceding clauses, wherein each M has an oxidation state of from +1 to +7.

5. The compound of formula I according to any one of the preceding clauses, wherein one or more of the following apply:

0.8<x≤1.2 (e.g. 0.8<x≤1.0);

1.9<z≤2.

6. The compound of formula I according to Clause 1, where the compound has formula Ia:

P3-NaₐFe_{b}Mn_{c}M′_{d}Oₑ Ia

where:

a>0.66;

0.8≤(b+c+d)≤1.0;

e≤2; and

M′ M is selected from one or more of the group consisting of a 3d transition metal, a 4d transition metal, Al, Mg, B, Si, Sn, Sr and Ca.

7. The compound of formula Ia according to Clause 6, where M′ is selected from one or more of the group consisting of Mn, Fe, Ni, Co, Cu, Ti, Cr, Zn, V, Sc, Y, Zr, Nb, Mo, Al, Mg, B, Si, Sn, Sr and Ca.

8. The compound of formula Ia according to Clause 6 or Clause 7, wherein M′ is selected from one or more of the group consisting of Mn, Fe, Ni, Co, Cu, Ti, Cr, Zn, V, Sc, Y, Zr, Nb, Mo, Al, Mg, B, and Ca, optionally wherein M is Ti.

9. The compound of formula Ia according to Clause 8, where M′ is Ti.

10. The compound of formula Ia according to any one of Clauses 6 to 9, wherein each M′ has an oxidation state of from +1 to +7.

11. The compound of formula Ia according to any one of Clauses 6 to 10, wherein one or more of the following apply:

(a) 0.8<a≤1.2;

(b) 0.4≤b≤0.6;

(c) 0.4≤c≤0.6;

(d) 0≤d≤0.1; and

(e) 1.9<e≤2.

12. The compound of formula Ia according to Clause 11, wherein one or more of the following apply:

(a) 0.8<a≤1.0;

(a) b is 0.5;

(b) 0.4≤c≤0.5; and

(c) e is 2.

13. The compound of formula Ia according to any one of the preceding clauses, wherein the compound is selected from:

(a) P3-Na_{0.8}Fe_{0.5}Mn_{0.5}O₂;

(b) P3-Na_{0.8}Fe_{0.5}Mn_{0.45}Ti_{0.05}O₂; and

(c) P3-Na_{0.8}Fe_{0.5}Mn_{0.4}Ti_{0.1}O₂.

14. A cathode comprising a stabilised Na-ion oxide P3 phase of formula I as described in any one of Clauses 1 to 13 as an active material therein.

15. A sodium-ion battery comprising a cathode as described in Clause 14 or a stabilised Na-ion oxide P3 phase of formula I as described in any one of Clauses 1 to 13 as an active material therein.

16. A method of forming a stabilised Na-ion oxide P3 phase of formula I as described in any one of Clauses 1 to 13, the process comprising the steps of:

(a) providing a powder comprising Na_{X}M_{y}O_{z}; and

(b) subjecting the powder to a temperature of from 750 to 1050° C. with a heating rate of from 2 to 15° C./min and a cooling rate of from 1 to 10° C./min for a total period of from 6 to 20 hours, wherein:

0.66<x<0.7;

0.8≤y≤1.0;

z≤2; and

M is selected from one or more of the group consisting of a 3d transition metal, a 4d transition metal, Al, Mg, B, Si, Sn, Sr and Ca.

17. A method of forming a stabilised Na-ion oxide P3 phase of formula I as described in any one of Clauses 1 to 13, the process comprising the steps of:

(a) providing a powder comprising a mixture of P3-NaₓM_{y}O_{z} and O3-NaₓM_{y}O_{z}; and

(b) subjecting the powder to a temperature of from 350 to 700° C. with a heating rate of from 2 to 15° C./min and a cooling rate of from 1 to 13° C./min for a total period of from 2 to 24 hours, wherein:

x>0.7;

0.8≤y≤1.0;

z≤2; and

M is selected from one or more of the group consisting of a 3d transition metal, a 4d transition metal, Al, Mg, B, Si, Sn, Sr and Ca.

18. The method of Clause 17, wherein the powder comprising a mixture of P3-NaₓM_{y}O_{z} and O3-NaₓM_{y}O_{z} is obtained using the method of Clause 16, except that x is >0.7.

19. A method of charging and discharging a Na-ion battery comprising a cathode as described in Clause 14 in a first charge/discharge cycle, wherein the method comprises the steps of charging and then discharging the Na-ion battery using a voltage window (cathode v/s Na/Na⁺) of from 4.45±0.2 V to 2.0±0.5 V.

20. A method of charging and discharging a Na-ion battery comprising a cathode as described in Clause 14 in a subsequent (i.e. after a first) charge/discharge cycle, wherein the method comprises the steps of charging and then discharging the Na-ion battery using a voltage window (cathode v/s Na/Na⁺) of from 4.2±0.05V to 2.0±0.5V.

### DRAWINGS

FIG. 1 depicts the experimental curves of powder X-ray diffraction of (a) O3+P3 powder; and (b) P3 powder.

FIG. 2 depicts the rietveId refinement of P3-Na_{0.8}Fe_{0.5}Mn_{0.5}O₂.

FIG. 3 shows the FE-SEM images of P3-Na_{0.8}Fe_{0.5}Mn_{0.5}O₂ at (a) 100×; (b) 1000×; and (c) 5000×.

FIG. 4 shows the charge/discharge protocol representing first and second cycle (subsequent cycles) in Na-ion half cell, electrolyte used—1M NaClO₄ in propylene carbonate.

FIG. 5 shows the cycling of P3-Na_{0.8}Fe_{0.5}Mn_{0.5}O₂ in Na-ion half cell with voltage windows as 4.30-2.0 V, 4.45-2.10 V and modified charge/discharge protocol (Current: 0.02 A/g).

FIG. 6 depicts the cycling performance of P3-Na_{0.8}Fe_{0.5}Mn_{0.5}O₂ and P3-Na_{0.8}Fe_{0.5}Mn_{0.45}Ti_{0.05}O₂ at 0.02 A/g current rate.

FIG. 7 shows the Na-ion layered oxide.

### DESCRIPTION

It has been surprisingly found that a stabilized P3 phase Na-ion layered oxide may be particularly useful in sodium ion batteries (NIBs). The class of material is Na-ion layered oxide, which can be further classified as O3 or P3 or P2 or O1 or P1. O stands for octahedrally coordinated Na-ions and P stands for prismatically coordinated Na-ions. Thus, in a first aspect of the invention, there is provided a stabilised Na-ion oxide P3 phase of formula I:

P3-NaₓM_{y}O_{z} I

where:

x>0.66;

0.8≤y≤1.0;

z≤2; and

M is selected from one or more of the group consisting of a 3d transition metal, a 4d transition metal, Al, Mg, B, Si, Sn, Sr and Ca, wherein the compound of formula I is suitable for use as a cathode active material in a Na-ion battery.

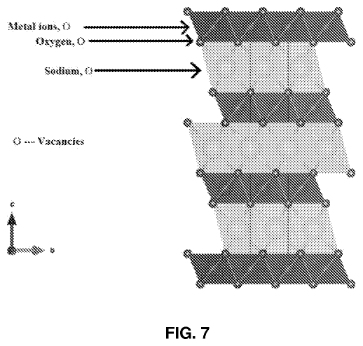

Referring to FIG. 7, Na and M can reside in Na-layers and is in perfect/distorted prismatic co-ordination with oxygen anions. The structure may also include the presence of vacancies on as explained in the experimental section herein.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase, “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure.

As used herein, the singular forms “a,” “an,” and “the” include plural referents unless the context clearly dictates otherwise. Thus, for example, reference to “a composition” includes mixtures of two or more such compositions, reference to “an oxygen carrier” includes mixtures of two or more such oxygen carriers, reference to “the catalyst” includes mixtures of two or more such catalysts, and the like.

As will be appreciated, M in the formula above may be selected from any suitable 3d transition metal or 4d transition and Al, Mg, B, Si, Sn, Sr and Ca, plus any suitable combination thereof. Examples of metals that may be present as M in formula I include, but are not limited to Mn, Fe, Ni, Co, Cu, Ti, Cr, Zn, V, Sc, Y, Zr, Nb, Mo, Al, Mg, B, Si, Sn, Sr, Ca and combinations thereof. In more particular embodiments of the invention, M may be selected from one or more of the group consisting of Mn, Fe, Ni, Co, Cu, Ti, Cr, Zn, V, Sc, Y, Zr, Nb, Mo, Al, Mg, B, and Ca. In particular embodiments of the invention that may be mentioned herein, M may be Ti.

As will be appreciated, M acts as a countercharge to the negatively charged oxygen ions within the Na-ion oxide and so each M will have a positive charge that, in combination with the +1 charge on Na renders the compound charge-neutral. For example, each M may an oxidation state of from +1 to +7. As will be appreciated, the actual possible charge for each of the metals above will have a maximum and minimum limit and so not all of the metals listed will be able to access all of these oxidations states.

In embodiments of the invention that may be mentioned herein, X may be greater than or equal to 0.67 (e.g. from 0.67 to 1.0). As such, excess sodium may be present in the active material.

In embodiments of the invention, that may be mentioned herein, one or both of the following may apply:

0.8<x≤1.2 (e.g. 0.8<x≤1.0); and

1.9<z≤2.

Particular compounds of formula I that may be disclosed herein may have the formula Ia:

P3-Na₆Fe_{b}Mn_{c}M′_{d}Oₑ Ia

where:

a>0.66;

0.8≤(b+c+d)≤1.0;

e≤2; and

M′ M is selected from one or more of the group consisting of a 3d transition metal, a 4d transition metal, Al, Mg, B, Si, Sn, Sr and Ca.

For the avoidance of doubt, while the current invention is directed at stabilized P3 materials of formula I, it will be appreciated that the mixture of a compound of formula I (or Ia) and another compound is also intended to be covered. As such, the invention also relates to mixtures of the compound of formula I (or Ia) and mixtures of it with other Na-containing materials, such as an O3 phase having the same chemical formula.

When used herein “stabilised” may refer to a material that is able to maintain the P3 phase following its formation and even when subjected to use in a battery cell. Without wishing to be bound by theory, it is believed that the stabilized P3 form is obtained following subjecting the material to sintering conditions. This may be a single sintering step for materials of formula I where x is less than 0.7, or it may be due to two sintering steps for materials where X is greater than 0.7.

As will be appreciated, M′ in the formula above may be selected from any suitable 3d transition metal or 4d transition and Al, Mg, B, Si, Sn, Sr and Ca, plus any suitable combination thereof. Examples of metals that may be present as M′ in formula Ia include, but are not limited to Mn, Fe, Ni, Co, Cu, Ti, Cr, Zn, V, Sc, Y, Zr, Nb, Mo, Al, Mg, B, Si, Sn, Sr, Ca and combinations thereof. In more particular embodiments of the invention, M′ may be selected from one or more of the group consisting of Mn, Fe, Ni, Co, Cu, Ti, Cr, Zn, V, Sc, Y, Zr, Nb, Mo, Al, Mg, B, and Ca. In particular embodiments of the invention that may be mentioned herein, M′ may be Ti.

As will be appreciated, M′ acts as a countercharge to the negatively charged oxygen ions within the Na-ion oxide and so each M′ will have a positive charge that, in combination with the +1 charge on Na renders the compound charge-neutral. For example, each M′ may an oxidation state of from +1 to +7. As will be appreciated, the actual possible charge for each of the metals above will have a maximum and minimum limit and so not all of the metals listed will be able to access all of these oxidations states.

In embodiments of the invention that may be mentioned herein, M and, when mentioned, M′ may be selected from one or more of the group consisting of a 3d transition metal, a 4d transition metal, Al, Mg, B, and Ca.

Compounds of formula Ia that may be mentioned herein may be ones in which one or more of the following apply:

(a) 0.8<a≤1.2;

(b) 0.4≤b≤0.6;

(c) 0.4≤c≤0.6;

(d) 0≤d≤0.1; and

(e) 1.9<e≤2.

For the avoidance of doubt, the above language is intended to apply to the use of each individually in the formula Ia, as well as any combination thereof.

For example, the compound of formula Ia may be one in which one or more of the following apply:

(a) 0.8<a≤1.0:

(a) b is 0.5;

(b) 0.4≤c≤0.5; and

(c) e is 2.

In particular embodiments of the invention, the compound of formula I (and Ia) may be selected from:

(a) P3-Na_{0.8}Fe_{0.5}Mn_{0.5}O₂;

(b) P3-Na_{0.8}Fe_{0.5}Mn_{0.45}Ti_{0.05}O₂; and

(c) P3-Na_{0.8}Fe_{0.5}Mn_{0.4}Ti_{0.1}O₂.

The methods used to manufacture the Na-ion oxide P3 phase of formula I as described above may be made by any suitable method. Two such methods will be described herein. In the first method, the process may comprise the steps of:

(a) providing a powder comprising NaₓM_{y}O_{z}; and

(b) subjecting the powder to a temperature of from 750 to 1050° C. with a heating rate of from 2 to 15° C./min and a cooling rate of from 1 to 10° C./min for a total period of from 6 to 20 hours, wherein:

0.66<x<0.7;

0.8≤y≤1.0;

z≤2; and

M is selected from one or more of the group consisting of a 3d transition metal, a 4d transition metal, Al, Mg, B, Si, Sn, Sr and Ca. It will be appreciated that the values of M, x, y and z are the same as discussed hereinbefore. As noted, it is believed that this process itself is sufficient when x is less than 0.7. In cases where x is greater than 0.7 (it will be appreciated that when x is 0.7 exactly the material would need to be analyses to see what phase(s) are present and treated appropriately), the step above may result in a mixture of P3-NaₓM_{y}O_{z} and O3-NaₓM_{y}O_{z}. It is possible to rectify this by a further heating step. Thus, there is also provided a method of forming a stabilised Na-ion oxide P3 phase of formula I as above, the process comprising the steps of:

(a) providing a powder comprising a mixture of P3-NaₓM_{y}O_{z} and O3-NaₓM_{y}O_{z}; and

(b) subjecting the powder to a temperature of from 350 to 700° C. with a heating rate of from 2 to 15° C./min and a cooling rate of from 1 to 13° C./min for a total period of from 2 to 24 hours, wherein:

x>0.7;

0.8≤y≤1.0;

z≤2; and

M is selected from one or more of the group consisting of a 3d transition metal, a 4d transition metal, Al, Mg, B, Si, Sn, Sr and Ca.

As noted above, the powder comprising a mixture of P3-NaₓM_{y}O_{z} and O3-NaₓM_{y}O_{z} may be obtained using the method described to generate P3-NaₓM_{y}O_{z}, except that x in formula I is >0.7.

NaₓM_{y}O_{z} may be obtained by mixing the precursors together and using a solution or solid state synthetic route along with citric acid and NH₄OH. It will be appreciated that this is simply the use of literature methodology or by analogy to literature methodology for each of the compounds of formula I and Ia mentioned herein. For example, Preferred methods of synthesis of these NaₓM_{y}O_{z} may include solid-state reactions, co-precipitation method, sol-gel synthesis and simple solution based mixing process. Further details of how NaₓM_{y}O_{z} may be obtained are provided in the examples section below.

As intimated hereinbefore, the compounds of formula I (and Ia) disclosed herein may be particularly suitable for use in the formation of a Na-ion battery (NIB). Thus, in a further aspect of the invention, there is disclosed a cathode comprising a stabilised Na-ion oxide P3 phase of formula I as described above as an active material therein. In a further related aspect, there is also disclosed a sodium-ion battery comprising a cathode as described above or a stabilised Na-ion oxide P3 phase of formula I as described above as an active material therein. In addition to their utility in NIBs, the compounds of formula I (and Ia) may be useful for the storage and/or sequestration of gases.

It will be appreciated that the cathode and the sodium-ion battery comprising a cathode may be formed using only a stabilised Na-ion oxide P3 phase of formula I as the active material or a combination of it and further materials, such as the O3 materials discussed herein.

The NIBs herein can be high voltage NIBs, which results from the wide voltage window of the electrolyte. The NIBs disclosed herein can have discharge plateaus that vary from 2.0 to 4.45 V (i.e. 2.3 to 4.3 V), owing to the use of the compounds of formula I in the cathodes of the NIB.

When used herein, “average voltage” refers to the weighted average of the voltage when considering the total delivered capacity by the full cell during a discharge cycle. Practically, the average voltage can be computed by calculating the area under the voltage vs specific capacity curve of a discharge cycle (the calculated area will be the specific energy density delivered by the full cell) and then dividing this value with the specific capacity (specific energy density=specific capacity*average voltage). When used herein, “coulombic efficiency”, refers to the efficiency with which charge (electrons) is transferred in a system facilitating an electrochemical reaction. In a full cell configuration, the coulombic efficiency is the ratio of the discharge capacity to the charge capacity of the full cell. In a half cell configuration for a cathode, the coulombic efficiency will be the ratio of discharge to charge capacity while the coulombic efficiency for an anode in a half cell configuration will be the ratio of the charge to the discharge capacity.

When used herein, “cycle life” refers to the cycle number whereby the cell can deliver 20% of the capacities it could deliver in the initial cycles.

The NIBs disclosed herein may have cycle lives of from 50 cycles to 50,000 charge/discharge cycles, such as from 100 cycles to 25,000 charge/discharge cycles, such as 300 cycles to 10,000 charge/discharge cycles. Additional suitable cycle lives may be from 50 to 5,000 charge/discharge cycles, such as from 100 cycles to 4,000 charge/discharge cycles, such as 300 cycles to 3,000 charge/discharge cycles. It will be appreciated that any of the low-end range numbers here (e.g. 50, 100, 300) may be combined with any of the higher range numbers (e.g. 3,000, 4,000, 5000, 10,000, 25,000, 30,000, 50000) to provide additional preferred ranges. The above may be particularly applicable to coin-cell, which may display greater than or equal to 30%, such as greater than or equal to 50% of the initial charge capacity on the final charge/discharge cycle. For industrial-scale cells, the NIBs may have cycle lives of from 50 to 6,000, such as from 100 to 3,000, such as 250 to 1,000 charge/discharge cycles, which industrial-scale cells may display greater than or equal to 30%, such as greater than or equal to 50% of the initial charge capacity on the final charge/discharge cycle.

Cathodes of the current invention may comprise a current collector with a layer of the active material thereon, which layer also comprises at least one of a binder and a conductive material (if required) in addition to the active material.

The current collector may be any suitable conductor for a cathode, for example, aluminium (Al), stainless steel, nickel-plated steel, and/or the like. It is also possible for a single cathode to contain more than one of the above materials in combination. Any suitable weight ratio may be used when the active materials above are used in combination. For example, the weight ratio for two active materials in a single cathode may range from 1:100 to 100:1, such as from 1:50 to 50:1, for example 1:1. In additional or alternative embodiments, the battery may comprise more than one cathode. When the battery contains more than one cathode (e.g. from two to 10, such as from 2 to 5 cathodes) the active materials may be chosen from those above and each cathode may independently contain only one cathode active material or a combination of two or more active materials as discussed above.

Other active materials that may be used in combination with the compound(s) of formula I (and Ia) that may be mentioned include, but are not limited to, Naₐ[Cu_{b}Fe_{c}Mn_{d}NiₑTi_{f}M_{g}]O₂ (where: 0≤a≤1; 0≤b≤0.3; 0≤c≤0.5; 0 d 0.6; 0≤e≤0.3; 0≤f≤0.2; and 0≤g≤0.4, and M is selected from one or more of the group consisting of Mo, Zn, Mg, Cr, Co, Zr, Al, Ca, K, Sr, Li, H, Sn, Te, Sb, Nb, Sc, Rb, Cs, and Na), or more particularly, M-Na₂Fe₂(CN)₆.2H₂O; R—Na₂Fe₂(CN)₆, NVP, and Na₄Mn₃(PO₄)₂(P₂O₇).

The binder improves binding properties of the positive active material particles with one another and the current collector. The binder may be a non-aqueous binder, an aqueous binder, or a combination thereof. The binder is not particularly limited as long as it binds the positive active material and the conductive material on a current collector, and simultaneously (or concurrently) has oxidation resistance for high potential of a cathode and electrolyte stability.

Non-aqueous binders that may be mentioned herein include, but are not limited to, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

Aqueous binders that may be mentioned herein include, but are not limited to, a rubber-based binder or a polymer resin binder. Rubber-based binders may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. Polymer resin binders may be selected from ethylenepropylene copolymer, epichlorohydrin, polyphosphazene, polyacrylonitrile, polystyrene, ethylenepropylenediene copolymer, polyvinylpyridine, chlorosulfonated polyethylene, latex, a polyester resin, an acrylic resin, a phenolic resin, an epoxy resin, polyvinyl alcohol and a combination thereof.

A cellulose-based compound may be used as the binder (or in combination with other materials). Examples of suitable cellulose-based materials includes, but is not limited to, one or more of carboxylmethyl cellulose, hydroxypropylmethyl cellulose, methyl cellulose, or alkali metal salts thereof. The alkali metal may be Na, K, or Li. Such a cellulose-based compound may be included in an amount of about 0.1 parts by weight to about 20 parts by weight based on 100 parts by weight of the active material. A particular cellulose-based binder that may be mentioned herein is the sodium salt of carboxylmethyl cellulose.

The conductive material improves conductivity of an electrode. Any electrically conductive material may be used as a conductive material, unless it causes a chemical change, and examples thereof may be natural graphite, artificial graphite, carbon black, acetylene black, ketjen black, carbon fiber and/or like carbon-based material; copper, nickel, aluminum, silver, and/or like metal powder or metal fiber and/or like metal-based material; polyphenylene derivative and/or like conductive polymer; and/or a mixture thereof.

Cathodes of the current invention may be manufactured using the following method. First, the active material(s), the conductive material, and the binder are mixed in a desirable ratio (e.g. active material(s):additive:binder ratio of from 70:20:10 to 96:2:2, specific ratios that may be mentioned include, but are not limited to 85:10:5 and 90:5:5) and dispersed in an aqueous solution and/or an organic solvent (such as N-methyl-2-pyrrolidone) to form a slurry.

Additionally or alternatively, the amount of active substance in the cathodes may be from 70 to 96 wt %, the amount of additive (e.g. conductive carbon) may be from 2 to 20 wt % and the amount of binder may also be from 2 to 10 wt %. Subsequently, the slurry is coated on a current collector and then dried to form an active material layer. Herein, the coating method is not particularly limited, and may be, for example, a knife coating method (e.g. Doctor knife coating), a gravure coating method, and/or the like. Then, the active material layer is compressed utilizing a compressor (such as a roll press) to a desirable thickness to manufacture an electrode. A thickness of the active material layer is not particularly limited, and may be any suitable thickness that is applicable to a positive active material layer of a rechargeable lithium or sodium battery. The active material loading may be from 1 to 50 mg cm⁻², for example the active material loading may be from 5 to 40 mg cm⁻², such as from 8 to 30 mg cm⁻².

The anode may be formed in similar manner to that described herein before. That is the anode may include a negative active material, and may further include a binder and a conductive additive.

The negative active material layer may be any suitable negative active material layer for a full cell battery (e.g. a NIB). For example, the negative active material may include a carbon-based material, a silicon-based material, a tin-based material, an antimony-based material, a lead-based material, a metal oxide (e.g. a lithium or sodium metal oxide), a sodium metal, and/or the like, which may be utilized singularly or as a mixture of two or more. The carbon-based material may be, for example, soft carbon or hard carbon or a graphite-based material such as artificial graphite, natural graphite, a mixture of artificial graphite and natural graphite, natural graphite coated with artificial graphite, and/or the like. The silicon-based material may be, for example, silicon, a silicon oxide, a silicon-containing alloy, a mixture of the graphite-based material with the foregoing materials, and/or the like. The silicon oxide may be represented by SiOₓ (0<x≤2). The silicon-containing alloy may be an alloy including silicon in the largest amount of the total metal elements (e.g., silicon being the metal element that is present in the largest amount of all the metal elements) based on the total amount of the alloy, for example, a Si—Al—Fe alloy. The tin-based material may be, for example, tin, a tin oxide, a tin-containing alloy, a mixture of the graphite-based material with the foregoing materials, and/or the like. Likewise for antimony and lead-based materials. The lithium metal oxide may be, for example, a titanium oxide compound such as Li₄Ti₅O₁₂, Li₂Ti₆O₁₃ or Li₂Ti₃O₇. The sodium metal oxide may be, for example, a titanium oxide compound such as Na₂Ti₃O₇ or Na₂Ti₆O₁₃. Other metal oxides that may be mentioned herein as suitable include, but are not limited to, TiO₂, Fe₂O₃, MoO₃. According to one embodiment, among them, graphite may further improve cycle-life characteristics of a NIB. In certain embodiments mentioned herein, the negative active material is not a tin-based material.

It will be appreciated that the above negative active materials may be used individually. That is, an anode may only contain one of the above negative active materials. However, it is also possible for a single anode to contain more than one of the above materials in combination. Any suitable weight ratio may be used when the active materials above are used in combination. For example, the weight ratio for two active materials in a single anode may range from 1:100 to 100:1, such as from 1:50 to 50:1, for example 1:1. In additional or alternative embodiments, the battery may comprise more than one anode. When the battery contains more than one anode (e.g. from two to 10, such as from 2 to 5 cathodes) the active materials may be chosen from those above and each anode may independently contain only one anode active material or a combination of two or more active materials as discussed above.

The binder and conductive additive (if any) are not particularly limited, and may be the same binder and conductive additive as that of the cathode.

A weight ratio of the negative active material and the binder is not particularly limited, and may be a weight ratio of a related art NIB.

The anode may be manufactured as follows. The negative active material(s), conductive additive (if required) and the binder are mixed in a desired ratio and the mixture is dispersed in an appropriate solvent (such as water and/or the like) to prepare a slurry. Then, the slurry is applied on a current collector and dried to form a negative active material layer. Then, the negative active material layer is compressed to have a desired thickness by utilizing a compressor, thereby manufacturing the anode. Herein, the negative active material layer has no particularly limited thickness, but may have any suitable thickness that a negative active material layer for a rechargeable lithium (or sodium) ion battery may have. In addition, when metal sodium is utilized as the negative active material layer, the metal sodium may be overlapped with (e.g., laminated or coated on) the current collector.

The sodium-ion battery also includes a separator. The separator is not particularly limited, and may be any suitable separator utilized for a sodium-ion battery. For example, a porous layer or a nonwoven fabric showing excellent high rate discharge performance and/or the like may be utilized alone or as a mixture (e.g., in a laminated structure).

A substrate of the separator may include, for example, a polyolefin-based resin, a polyester-based resin, polyvinylidene difluoride (PVDF), a vinylidene difluoride-hexafluoropropylene copolymer, a vinylidene difluoride-perfluorovinylether copolymer, a vinylidene difluoride-tetrafluoroethylene copolymer, a vinylidene difluoride-trifluoroethylene copolymer, a vinylidene difluoride-fluoroethylene copolymer, a vinylidene difluoride-hexafluoroacetone copolymer, a vinylidene difluoride-ethylene copolymer, a vinylidene difluoride-propylene copolymer, a vinylidene difluoride-trifluoropropylene copolymer, a vinylidene difluoride-tetrafluoroethylene-hexafluoropropylene copolymer, a vinylidene difluoride-ethylene-tetrafluoroethylene copolymer, and/or the like. The polyolefin-based resin may be polyethylene, polypropylene, and/or the like; and the polyester-based resin may be polyethylene terephthalate, polybutylene terephthalate, and/or the like.

The porosity of the separator is not particularly limited, and may be any suitable porosity that a separator of a sodium-ion battery may have.

The separator may include a coating layer including an inorganic filler may be formed on at least one side of the substrate. The inorganic filler may include Al₂O₃, Mg(OH)₂, SiO₂, and/or the like. The coating layer including the inorganic filler may inhibit direct contact between the positive electrode and the separator, inhibit oxidation and decomposition of an electrolyte on the surface of the positive electrode during storage at a high temperature, and suppress the generation of gas which is a decomposed product of the electrolyte. A suitable separator that may be mentioned herein is a glass fibre separator.

It will be appreciated that any of the above separators may be used in the aspects and embodiments of the current invention, provided that they are a technically sensible choice.

Any suitable electrolyte (e.g. non-aqueous electrolyte) may be used in the NIB. Examples of suitable electrolyte materials include, but are not limited to NaClO₄ and propylene carbonate. The electrolyte can contain any combination of soluble Na-salts in various organic solvents or mixture of solvents. The molarity of solution can vary from 0.3-15.0M. Salts can be taken from NaClO₄(Sodium perchlorate), NaPF₆ (Sodium hexafluorophosphate), NaBF₄ (Sodium tetrafluoroborate), NaB(Ph)₄ (Sodium tetraphenyl borate), NaTFSI (Sodium Bis(trifluoromethanesulfonyl) imide), NaFSI (Sodium Bis(fluoro methane sulfonyl)imide), NaOTf (Sodium trifluoro methanesulfonate), NaBOB (Sodium Bis(oxalato) Borate), NaDFOB (Sodium Difluoro Bis(oxalato) Borate). Solvents can be selected from one or more of EC (Ethylene carbonate), DEC (Diethylene Carbonate), PC(Propylene Carbonate), Dimethyl Carbonate (DMC), Diglyme, Monoglyme, Tetraglyme, Trimethyl Phosphate, Dimethyl Formamide, Acetonitrile, and Dimethyl Sulfoxide.

The electrolyte may further include various suitable additives such as a negative electrode SEI (Solid Electrolyte Interface) forming agent or positive electrode CEI (Cathode Electrolyte Interface), a surfactant, and/or the like. Such additives may be, for example, succinic anhydride, lithium bis(oxalato)borate, sodium bis(oxalato)borate, lithium tetrafluoroborate, a dinitrile compound, propane sultone, butane sultone, propene sultone, 3-sulfolene, a fluorinated allylether, a fluorinated acrylate, carbonates such as vinylene carbonate, vinyl ethylene carbonate and fluoroethylene carbonate and/or the like. The concentration of the additives may be any suitable one that is utilized in a general NIB. Particular additives that may be included in the electrolyte are those selected from one or more of the group consisting of fluoroethylene carbonate (FEC), vinylene carbonate (VC), vinyl ethylene carbonate (VEC), biphenyl, and adiponitrile. The above additives may be present in any suitable weight ratio.

In a NIB, the separator may be disposed between the positive electrode and the negative electrode to manufacture an electrode structure, and the electrode structure is processed to have a desired shape, for example, a cylinder, a prism, a laminate shape, a button shape, and/or the like, and inserted into a container having the same shape. Then, the non-aqueous electrolyte is injected into the container, and the electrolyte is impregnated in the pores in the separator, thereby manufacturing a rechargeable sodium or sodium-ion battery.

Hereinafter, embodiments of the invention are illustrated in more detail with reference to the following examples. However, the present disclosure is not limited thereto. Furthermore, what is not described in this disclosure may be sufficiently understood by those who have knowledge in this field and will not be illustrated herein.

Without wishing to be bound by theory, it is believed that particularly good cycling performance can be obtained for NIBs utilizing the compound of formula I (and Ia) as the active material in a cathode by careful control of the first charge/discharge cycle. Thus, in a further aspect of the invention, there is also provided a method of charging and discharging a Na-ion battery comprising a cathode as above in a first charge/discharge cycle, wherein the method comprises the steps of charging and then discharging the Na-ion battery using a voltage window (cathode v/s Na/Na⁺) of from 4.45±0.2 V to 2.0±0.5 V.

Particularly good performance for NIBs according to the current invention may also be obtained by controlling the subsequent charge and discharge cycles. As such, there is also provided a method of charging and discharging a Na-ion battery comprising a cathode as described in the first charge/discharge cycle above in a subsequent (i.e. after a first) charge/discharge cycle, wherein the method comprises the steps of charging and then discharging the Na-ion battery using a voltage window (cathode v/s Na/Na⁺) of from 4.2±0.05V to 2.0±0.5V.

The disclosed materials herein provides materials that have higher charge capacities as compared to existing O3/P2 phase materials. This opens up the opportunity of stabilizing a plethora of P3 phases in the composition of previously reported O3 and P2 phases. The existing cathodes for Na-ion batteries are either pure O3 or pure P2 or combination of different phases. The limitation of O3 materials is their cycling performance due to huge phase transformations when high amount of Na-ions are extracted from the structure, on the other hand P2 structures have better cycling due to more favorable kinetics when Na-ions are in prismatic coordination. However, P2 layered oxides have a scarcity of Na-ions which limits their first charge capacity. The materials disclosed herein make use of a material where x is greater than 0.66 (e.g. x can be 0.8), thus increasing charge capacity and avoiding the use of external Na-ion sources which ultimately lowers the overall energy density of the Na-ion cell.

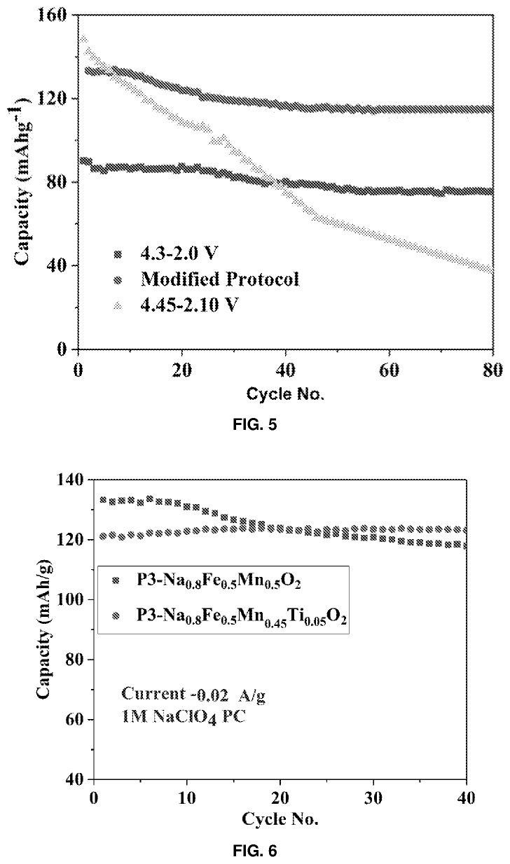

In addition, the disclosed charge/discharge protocol provides a stable cycling performance, which is at par with most of the O3 phases known, but with a higher capacity. This protocol also provides extra Na-ions as the moles of Na-ions extracted during charge exceeds moles of Na-ions inserted during discharge (e.g. see FIG. 5: 162 mAh/g>148 mAh/g); these extra Na-ions can as well compensate the Na-ions lost during SEI (solid electrolyte interphase) formation at the anode during the formation cycle (first cycle), for e.g. at Hard Carbon when used as anode material.

Further aspects and embodiments of the invention will now be described by reference to the following non-limiting examples.

### EXAMPLES

Materials

For the preparation of Na_{0.8}Fe_{0.5}Mn_{0.45}Ti_{0.05}O₂, we list required starting materials here: sodium carbonate (Na₂CO₃) (98% purity), iron(II) acetate (CH₃(COO)₂Fe) (97% purity), manganese(II) carbonate (MnCO₃) (98+% purity), ammonium hydroxide (NH₄OH) (50% v/v), Titanium Isopropoxide (C₁₂H₂₈O₄Ti) (97% purity) and Super P conductive carbon were purchased from Alfa Aesar. PVDF powder was purchased from Kureha. Sodium perchlorate (NaClO₄) (98% purity), N-methyl-2-pyrrolidone (99.5% purity) and propylene carbonate (99.7% purity) were purchased from Sigma Aldrich. All of the chemicals were used without further modification.

Analytical Techniques

Powder XRD was recorded using Bruker Advance which uses Cu-Kα radiation (Voltage=40 kV and Current=40 mA). Rietveld refinement was performed using TOPAS V6. Field Emission Scanning Electron Microscopy data was collected using JEOL-JSM 7000F for morphology studies. Metal ratios were detected by Inductively coupled plasma mass spectroscopy (ICP-MS).

### Example 1

General Procedure

The method to prepare NaₓFe_{y}Mn_{z}MₙO_{w} is provided below. M can be any 3d-transition metal or 4d-transition metal or alkali metals or Al³⁺, Mg²⁺, B³⁺, Ca²⁺ etc., or combinations of these elements. The oxidation state of M can be +2, +3, +4, +5, +6 and +7 depending on x, y.

Stoichiometric amounts of salts of Na, Fe, Mn and M were mixed with 0.5 molar equivalent of citric acid in a solvent (water/methanol/ethanol), and mixing was allowed for 1-4 h. The pH of the solution at this stage was c.a. 3.85. After mixing, NH₄OH solution was added to adjust the pH to 7.5-10.0. The mixing was continued for 24 h. The resultant mixture was dried over a hot plate at 100-180° C. for 8-10 h. The dried powder was ground using conventional grinding techniques. The powder was then sintered at 750-1050° C. with a heating rate of 2-15° C./min and a cooling rate of 1-10° C./min for 6-20 h. The powder was quenched to room temperature from 200-550° C. or allowed to cool down to room temperature depending on the desired surface properties of the resultant oxide. After cooling/quenching, the obtained powder was found to be either a mixture of P3 and O3 phase or a pure P3 phase depending on the values of x,y,z and n. The mixture of P3 and O3 phase (mostly for x>0.7 in NaₓMO₂) was further sintered at 350-700° C. for 2-24 h with a heating rate of 2-15° C./min and a cooling rate of 1-10° C./min. The powder was quenched to room temperature from 200-550° C. or allowed to cool down to room temperature depending on the desired surface properties of the resultant oxide.

The procedure described above were used to manufacture the following Na-ion layered oxides.

1. P3-Na_{0.8}Fe_{0.5}Mn_{0.5}O₂

The general procedure was adapted as follows for producing 10 mmol of P3-Na_{0.8}Fe_{0.5}Mn_{0.5}O₂, stoichiometric amount of precursors and 0.5 molar equivalent of citric acid were taken. That is, 4.0 mmol of Na₂CO₃, 5 mmol of (CH₃COO)₂Fe, 5 mmol of MnCO₃ and 5 mmol of citric acid were mixed in 50 ml Deionized (DI) water. The pH of the solution at this stage was c.a. 3.85. After 15 min of mixing, 50% (v/v) NH₄OH solution was added to the previous solution to adjust the pH to 9.0. The solution was mixed for 24 h. After mixing, the solution was transferred to a crystal dish and dried on a hotplate at 120° C. for 8-10 h. The dried powder was scrapped off the dish and crushed using mortar and pestle. The powder was then calcined in a muffle furnace at 900 □ for 15 h. The ramp rate was 5° C./min (both during heating and cooling). The furnace was allowed to cool down to room temperature. After cooling to room temperature, the furnace was again heated to 500° C. for 2 h with a ramp rate of 5° C./min. During cooling of the furnace, the powder was taken out at 300° C. to quench it in air and kept on a copper plate to enhance heat transfer.

2. P3-Na_{0.8}Fe_{0.5}Mn_{0.45}Ti_{0.05}O₂

The general procedure was adapted as follows for producing 10 mmol of P3-Na_{0.8}Fe_{0.5}Mn_{0.45}Ti_{0.05}O₂, stoichiometric amounts of precursors and 0.5 molar equivalent of citric acid were taken. That is, 4.0 mmol of Na₂CO₃, 5 mmol of (CH₃COO)₂Fe, 4.5 mmol of MnCO₃, 0.5 mmol of C₁₂H₂₃O₄Ti and 5 mmol of citric acid were mixed in 50 ml Deionized (DI) water. The pH of the solution at this stage was c.a. 3.8. After 15 min of mixing, 50% (v/v) NH₄OH solution was added to the previous solution to adjust the pH to 9.0. The solution was mixed for 24 h. After mixing, the solution was transferred to a crystal dish and dried on a hotplate at 120° C. for 8-10 h. The dried powder was scrapped off the dish and crushed using mortar and pestle. The powder was then calcined in a muffle furnace at 950° C. for 12 h. The ramp rate was 5° C./min (both during heating and cooling). The furnace was allowed to cool down to room temperature. After cooling to room temperature, the furnace was again heated to 500° C. for 2 h with a ramp rate of 5° C./min. During cooling of the furnace, the powder was taken out at 300° C. to quench it in air and kept on a copper plate to enhance heat transfer.

3. P3-Na_{0.8}Fe_{0.5}Mn_{0.4}Ti_{0.1}O₂

The general procedure was adapted as follows for producing 10 mmol of P3-Na_{0.8}Fe_{0.5}Mn_{0.40}Ti_{0.10}O₂, stoichiometric amounts of precursors and 0.5 molar equivalent of citric acid were taken. That is, 4.0 mmol of Na₂CO₃, 5 mmol of (CH₃COO)₂Fe, 4.0 mmol of MnCO₃, 1 mmol of C₁₂H₂₃O₄Ti and 5 mmol of citric acid were mixed in 50 ml Deionized (DI) water. The pH of the solution at this stage was c.a. 3.8. After 15 min of mixing, 50% (v/v) NH₄OH solution was added to the previous solution to adjust the pH to 9.0. The solution was mixed for 24 h. After mixing, the solution was transferred to a crystal dish and dried on a hotplate at 120° C. for 8-10 h. The dried powder was scrapped off the dish and crushed using mortar and pestle. The powder was then calcined in a muffle furnace at 950° C. for 12 h. The ramp rate was 5° C./min (both during heating and cooling). The furnace was allowed to cool down to room temperature. After cooling to room temperature, the furnace was again heated to 500 □ for 2 h with a ramp rate of 5° C./min. During cooling of the furnace, the powder was taken out at 300° C. to quench it in air and kept on a copper plate to enhance heat transfer.

Characterization

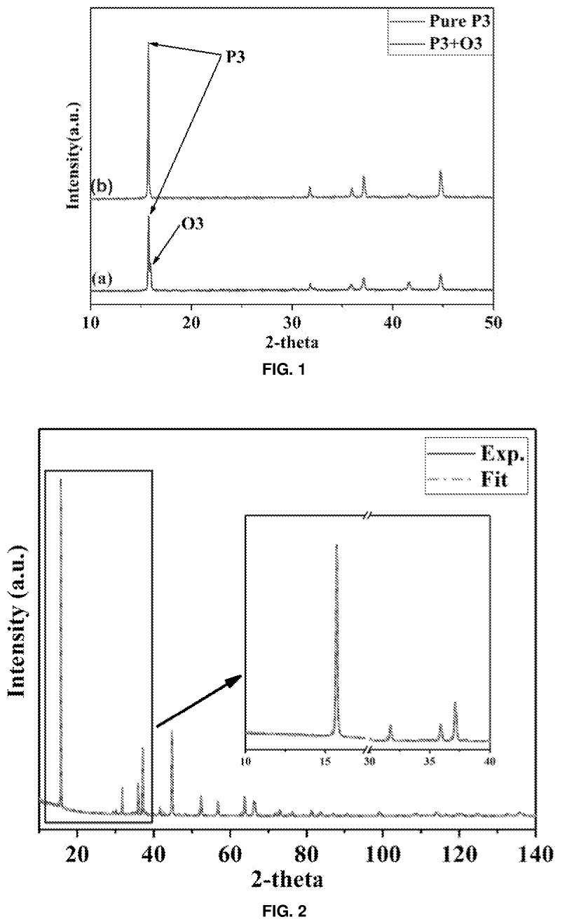

FIG. 1 shows the X-ray diffraction patterns of the product obtained after the first calcination step. For higher values of x (x>0.7), the material obtained was a mixture of O3 and P3 phase.

After the second calcination step, the mixture of P3 and O3 phase transformed into pure P3 phase. On the other hand, for x<0.7, a pure P3 phase was obtained after the first calcination step.

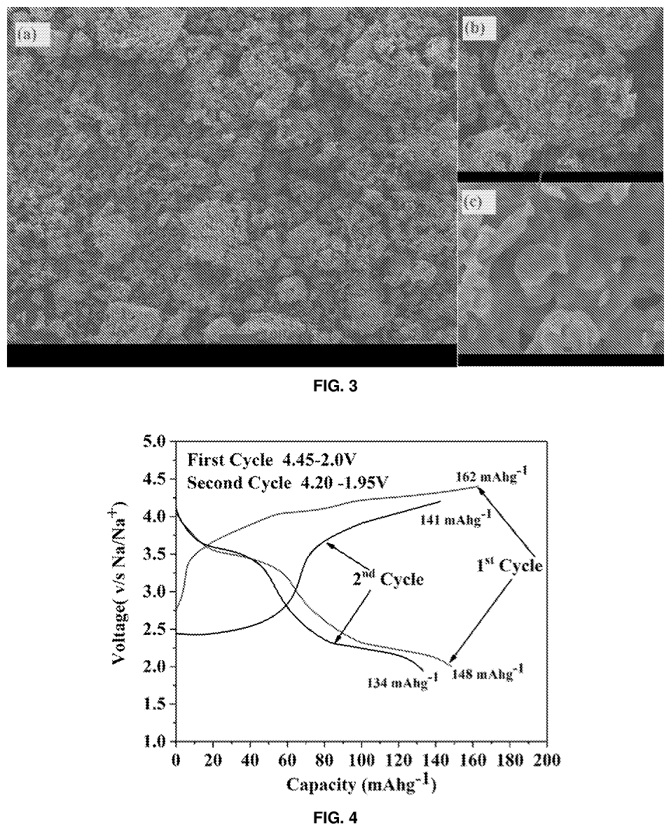

Particularly, Table 1 shows the ICP-MS results for the target material with x=0.8, y=0.5, z=0.5, n=0 and w=2. These results confirm that the obtained chemical composition is Na_{0.8}Fe_{0.5}Mn_{0.5}O₂. FIG. 2 shows the Rietveld Refinement for P3-Na_{0.8}Fe_{0.5}Mn_{0.5}O₂ fitted with the space-group R3m while FIG. 3 shows the FE-SEM images of P3-Na_{0.8}Fe_{0.5}Mn_{0.5}O₂ which consist of agglomeration of micron-size (2-5 μm) primary particles.

TABLE 1
ICP-MS results for Na_{0.8}Fe_{0.5}Mn_{0.5}O₂.
ICP Results (weight %)

| | Expected | Observed |
|---|---|---|
| Na | 17.39 | 16.68 |
| Fe | 26.39 | 24.89 |
| Mn | 25.96 | 24.11 |

### Example 2

The experimental procedures for battery making and testing are provided below. 2016 type coin cells were assembled for Galvanostatic (constant current) testing in both full cell and half cell formats. Half cells were tested against Na-metal as the counter electrode. P3-Na_{0.8}Fe_{0.5}Mn_{0.5}O₂ electrodes were prepared by making a slurry of P3-Na_{0.8}Fe_{0.5}Mn_{0.5}O₂ powder, Super P conductive carbon and PVDF powder in N-methyl-2-pyrrolidone in the wt./wt. ratio of 80:10:10 respectively. The slurry was coated on an aluminium foil and dried in vacuum at 110° C. for 6 h. The coated electrodes were roll pressed at 4 kN and disks of 1 cm² were punched out of them. The active material loading of these electrodes were in the range of 6-8 mg/cm². These electrode disks were dried in antechamber at 110° C. in vacuum before cell assembly. Coin cell assembly was done in Argon filled Glovebox (MBraun) with H₂O and O₂ concentration lower than 1 ppm. Whatman Glass Fibre (Sigma Aldrich) separators were used as the separators during coin cell assembly and 1 M NaClO₄ in propylene carbonate was used as the electrolyte for both full cells and half cells. Full cells were assembled with Hard Carbon composite electrodes (95% Hard Carbon, 5% Sodium salt of carboxy-methyl cellulose). The cathode to anode active material ratio was fixed as 1.65. All galvanostatic testing was carried out on Arbin testers.

### Example 3

The modified charge/discharge protocol in a sodium/sodium-ion battery with conventional anodes (prepared in Example 2) is provided below. The voltage window for full cell is determined through voltage window of this material versus Na/Na⁺ when used as a cathode material.

In the modified charge/discharge protocol, the voltage window for the first cycle—V (cathode v/s Na/Na⁺) is 4.45±0.2 V to 2.0±0.5 V, and the voltage window for second and subsequent cycles—V (cathode v/s Na/Na⁺) is 4.2±0.05V to 2.0±0.5V.

Results and Discussion

FIG. 4 demonstrates an example of this cycling protocol. The voltage window in subsequent cycle is the same as that of second cycle as shown in FIG. 4. FIG. 5 depicts the cycling performance with three different charge/discharge protocols. These results showed that this modified charge/discharge protocol helped to improve cycling performance. As mentioned previously, this modified protocol also provided extra Na-ions as the moles of Na-ions extracted during charge exceeds moles of Na-ions inserted during discharge (FIG. 5: 162 mAh/g>148 mAh/g) and these extra Na-ions can compensate the Na-ions lost during SEI (solid electrolyte interphase) formation at the anode during the formation cycle (first cycle), for example, at Hard Carbon when it is used as the anode material.

### Example 4

To show that the materials prepared in Example 1 provide stable cycling, the materials were taken for cycling performance tests using the procedures described in Example 2 and 3.

Results and Discussion

FIG. 6 shows the cycling performance of P3-Na_{0.8}Fe_{0.5}Mn_{0.5}O₂ and P3-Na_{0.8}Fe_{0.5}Mn_{0.45}Ti_{0.05}O₂ at 0.020 A/g rate. Indeed, these results show that P3-Na_{0.8}Fe_{0.5}Mn_{0.45}Ti_{0.05}O₂ and P3-NaₓMO₂ prepared by the synthetic method in Example 1 stabilize P3 phase.

1. A stabilised Na-ion oxide P3 phase of formula I:
P3-NaₓM_{y}O_{z} I
where:
x>0.66;
0.8≤y≤1.0;
z≤2; and
M is selected from one or more of the group consisting of a 3d transition metal, a 4d transition metal, Al, Mg, B, Si, Sn, Sr and Ca, wherein the compound of formula I is suitable for use as a cathode active material in a Na-ion battery.

2. The compound of formula I according to claim 1, wherein M is selected from one or more of the group consisting of Mn, Fe, Ni, Co, Cu, Ti, Cr, Zn, V, Sc, Y, Zr, Nb, Mo, Al, Mg, B, Si, Sn, Sr and Ca.

3. The compound of formula I according to claim 1, wherein M is selected from one or more of the group consisting of Mn, Fe, Ni, Co, Cu, Ti, Cr, Zn, V, Sc, Y, Zr, Nb, Mo, Al, Mg, B, and Ca.

4. The compound of formula I according to claim 1, wherein each M has an oxidation state of from +1 to +7.

5. The compound of formula I according to claim 1, wherein one or more of the following apply:
0.8<x≤1.2 (e.g. 0.8<x≤1.0);
1.9<z≤2.

6. The compound of formula I according to claim 1, where the compound has formula Ia:
P3-NaₐFe_{b}Mn_{c}M′_{d}Oₑ Ia
where:
a>0.66;
0.8≤(b+c+d)≤1.0;
e≤2; and
M′ M is selected from one or more of the group consisting of a 3d transition metal, a 4d transition metal, Al, Mg, B, Si, Sn, Sr and Ca.

7. The compound of formula Ia according to claim 6, where M′ is selected from one or more of the group consisting of Mn, Fe, Ni, Co, Cu, Ti, Cr, Zn, V, Sc, Y, Zr, Nb, Mo, Al, Mg, B, Si, Sn, Sr and Ca.

8. The compound of formula Ia according to claim 6, wherein M′ is selected from one or more of the group consisting of Mn, Fe, Ni, Co, Cu, Ti, Cr, Zn, V, Sc, Y, Zr, Nb, Mo, Al, Mg, B, and Ca.

9. The compound of formula Ia according to claim 8, where M′ is Ti.

10. The compound of formula Ia according to claim 6, wherein each M′ has an oxidation state of from +1 to +7.

11. The compound of formula Ia according to claim 6, wherein one or more of the following apply:
(a) 0.8<a≤1.2;
(b) 0.4≤b≤0.6;
(c) 0.4≤c≤0.6;
(d) 0≤d≤0.1; and
(e) 1.9<e≤2.

12. The compound of formula Ia according to claim 11, wherein one or more of the following apply:
(a) 0.8<a≤1.0;
(a) b is 0.5;
(b) 0.4≤c≤0.5; and
(c) e is 2.

13. The compound of formula I according to claim 1, wherein the compound is selected from:
(a) P3-Na_{0.8}Fe_{0.5}Mn_{0.5}O₂;
(b) P3-Na_{0.8}Fe_{0.5}Mn_{0.45}Ti_{0.05}O₂; and
(c) P3-Na_{0.8}Fe_{0.5}Mn_{0.4}Ti_{0.1}O₂.

14. A cathode comprising a stabilised Na-ion oxide P3 phase of formula I as described in claim 1 as an active material therein.

15. A sodium-ion battery comprising a cathode as described in claim 14 as an active material therein.

16. A method of forming a stabilised Na-ion oxide P3 phase of formula I as described in claim 1, the process comprising the steps of:
(a) providing a powder comprising NaₓM_{y}O_{z}; and
(b) subjecting the powder to a temperature of from 750 to 1050° C. with a heating rate of from 2 to 15° C./min and a cooling rate of from 1 to 10° C./min for a total period of from 6 to 20 hours, wherein:
0.66<x<0.7;
0.8≤y≤1.0;
z≤2; and
M is selected from one or more of the group consisting of a 3d transition metal, a 4d transition metal, Al, Mg, B, Si, Sn, Sr and Ca.

17. A method of forming a stabilised Na-ion oxide P3 phase of formula I as described in claim 1, the process comprising the steps of:
(a) providing a powder comprising a mixture of P3-NaₓM_{y}O_{z} and O3-NaₓM_{y}O_{z}; and
(b) subjecting the powder to a temperature of from 350 to 700° C. with a heating rate of from 2 to 15° C./min and a cooling rate of from 1 to 13° C./min for a total period of from 2 to 24 hours, wherein:
x>0.7;
0.8≤y≤1.0;
z≤2; and
M is selected from one or more of the group consisting of a 3d transition metal, a 4d transition metal, Al, Mg, B, Si, Sn, Sr and Ca.

18. (canceled)

19. A method of charging and discharging a Na-ion battery comprising a cathode as described in claim 14 in a first charge/discharge cycle, wherein the method comprises the steps of charging and then discharging the Na-ion battery using a voltage window (cathode v/s Na/Na⁺) of from 4.45±0.2 V to 2.0±0.5 V.

20. A method of charging and discharging a Na-ion battery comprising a cathode as described in claim 14 in a subsequent (i.e. after a first) charge/discharge cycle, wherein the method comprises the steps of charging and then discharging the Na-ion battery using a voltage window (cathode v/s Na/Na⁺) of from 4.2±0.05V to 2.0±0.5V.
